(19) United States
(12) Patent Application Publication
(10) Pub. No.: US 2022/0220640 A1
(43) Pub. Date: Jul. 14, 2022

(54) METHOD AND DEVICE FOR REGENERATING A SOLVENT OF CELLULOSE FROM A SPINNING PROCESS

(71) Applicant: AUROTECH GMBH, Regau (AT)

(72) Inventors: Stefan ZIKELI, Regau (AT); Friedrich ECKER, Timelkam (AT); Philipp ZAUNER, Vöcklabruck (AT)

(21) Appl. No.: 17/595,532

(22) PCT Filed: May 20, 2020
(86) PCT No.: PCT/EP2020/064019

§ 371 Date: Nov. 18, 2021

(30) Foreign Application Priority Data
May 21, 2019 (EP) 19175647.7

(51) Int. Cl. D01F 13/02

(52) U.S. Cl. CPC D01F 13/02

(57) ABSTRACT

A process and a device for regenerating a solvent for cellulose in a shaped cellulose article production process, including the steps of starting a continuous process for the production of solid shaped cellulose articles from a cellulose solution which includes the steps of: i) providing a cellulose solution of dissolved cellulose and a cellulose solvent and preferably a non-solvent, particularly preferably water, ii) shaping the cellulose solution into a desired geometrical shape, iii) consolidating the shaped cellulose solution into shaped cellulose articles in a coagulation liquid, iv) washing the shaped cellulose articles, wherein upon start-up and/or during the continuous process, shaped article waste of the cellulose solution accrues in an unwanted form, collecting the shaped article waste in the unwanted form, comminuting the shaped article waste, extracting solvent from the comminuted shaped article waste.

The present invention related to a process for regenerating a solvent for cellulose in a spinning process.

### BACKGROUND OF THE INVENTION

Various spinning processes for cellulosic materials are known, in particular the viscose process and the lyocell process. Lyocell is a generic name given by the BISFA (The International Bureau for the Standardization of Man-Made Fibres) to cellulose fibres which are produced from cellulose without the formation of a derivative. While the viscose process is based on an alkaline derivatisation of cellulose, in order to transform it into a spinnable dissolved form, the lyocell process uses solvents for cellulose which do not modify it (see Zhang et al., BioResources 13(2), 2018: 4577-4592 for a summary of the differences between these processes). Furthermore, the lyocell process requires energy-intensive regeneration of the solvent, which is the main reason for the high costs and the low efficiency (Perepelkin, Fibre Chemistry 39(2), 2007: 163-172). As an example, U.S. Pat. No. 8,932,471 proposes a three-stage evaporation process in order to evaporate water from a liquid containing solvent arising during the spinning process, in order to concentrate the dissolution substance (N-methylmorpholine N-oxide; abbreviated to NMMO or NMMNO), so that the mixture obtained can be used again for dissolving cellulose. This evaporation is extremely energy-intensive.

A summary of the lyocell process can be found in Singha, International Journal of Materials Engineering 2012, 2(3): 10-16. In brief, the process comprises the steps of dissolving cellulose from a cellulosic pulp, for example wood pulp. The solvent used may be a NMMO-water mixture, wherein the NMMO fraction should be 76-78% for dissolution at 70° C.-90° C. The cellulose solution obtained is filtered, spun by means of an extrusion process in a spinning bath (bath formed from a NMMO-water mixture with a NMMO fraction below the limit of solubility for cellulose), the coagulated cellulose solution is washed, dried and cut into fibres of the desired length. Solvent which accrues from the spinning and washing processes is purified (filtration, ion exchange) and, by means of evaporating off the high proportion of water, is brought to a NMMO concentration such that the mixture is again suitable for dissolving cellulose. Fresh NMMO is added to replace the NMMO which is not regenerated.

### SUMMARY OF THE INVENTION

A problem with previous processes is that the regeneration of the solvent is not complete. An additional problem is that in the lyocell process, a variety of stations are present from which solvent can be lost.

Thus, the objective of the invention is to provide an improved process with more efficient regeneration of the cellulose solvent. In particular, recycling of the aqueous solvent for cellulose should be obtained, so that the economic efficiency of cellulose fibre production processes is improved.

The invention concerns a process for extracting or for regenerating a solvent for cellulose in a shaped cellulose article production process, comprising the steps of:

A) continuously or discontinuously producing solid shaped cellulose articles from a cellulose solution, which comprises the steps of:
i) providing a cellulose solution of dissolved cellulose and a cellulose solvent and preferably further a non-solvent, particularly preferably water,
ii) shaping the cellulose solution into a desired geometrical shape,
iii) consolidating the shaped cellulose solution into shaped cellulose articles in a coagulation liquid,
iv) releasing or extracting the solvent from the shaped cellulose articles,
wherein, during the continuous or discontinuous process, shaped article waste from the cellulose solution accrues in an unwanted shape and optionally in the desired shape,

B) collecting the shaped article waste in the unwanted shape and optionally in the desired shape,

C) comminuting the shaped article waste from step B),

D) extracting solvent from the comminuted shaped article waste.

Furthermore, the invention concerns a device for carrying out this process. As an example, the invention concerns a device for regenerating a solvent for cellulose in a process for the production of shaped cellulose articles, comprising a spinning unit with an extruder, a container for coagulation liquid which is disposed downstream of a gap below the extruder, and a device for withdrawing consolidated shaped cellulose articles from the container, a solids collecting container for consolidated shaped cellulose articles and a comminutor for consolidated shaped cellulose articles. The invention also concerns the use of the device for collecting and comminuting the consolidated shaped cellulose articles and for carrying out the process in accordance with the invention.

All of the aspects of the device and process will be described below together in more detail; in this regard, the details will always be relevant to both aspects: descriptions of the process or of steps of the process are relevant to the device in the context of parts of the device for this process or steps; descriptions of the device are also relevant to means for carrying out the process.

### DESCRIPTION OF THE FIGURES

FIG. 1 shows locations where the solvent-containing flow of waste can accrue in the lyocell process.

FIG. 2 shows individual items in mixed waste after the pre-comminution step. Dimensions in cm.

FIG. 3 shows cellulose waste product after extraction of the solvent and after dewatering.

FIG. 4 shows a simplified block diagram of a solvent recycling process.

FIG. 5 illustrates the overall NMMNO balance for a lyocell production unit.

FIG. 6 shows a comminutor.

FIG. 7 shows a rotor with cutting elements of a comminutor.

FIG. 8 shows a rotor with spiral-shaped comminutors (a), a rotor with toothed cutting edges and a diametrically opposed toothed counter-cutting edge (b) and a lateral view of the positioning of the rotor against the counter-cutting edge in a comminutor (b).

FIG. 9 shows sieves for a comminutor.

### DETAILED DESCRIPTION OF THE INVENTION

Solvents for cellulose are comparatively very expensive and thus have to be intensively recycled to the process via closed loops. Although the lyocell process has been successfully used for many years for the production of cellulose products, high recovery rates of >99.5% are necessary in order to be able satisfy economic and ecological demands. Additional increases in the recovery rate for the solvent, even to a small extent above the usual rate, would be a substantial advantage.

In accordance with the process according to the invention, solvents for cellulose are collected and regenerated. In a shaped cellulose article production process such as the lyocell process, in various steps, waste accrues which still contains solvent. This waste may be liquids or solids (shaped article waste). Liquids with solvents can be extracted from the shaped article waste which, together with the direct liquid waste from the lyocell process (or the like), can be treated in order to collect or regenerate the solvent for repeated use in the process.

Shaped articles are usually produced continuously, but also discontinuously. Particularly when a continuous process is started up, a lot of shaped article waste accrues which is collected and treated in accordance with the invention. A process for the production of solid shaped cellulose articles from a cellulose solution, such as the lyocell process, comprises the steps of:

i) providing a cellulose solution of dissolved cellulose and a cellulose solvent and preferably a non-solvent, particularly preferably water,

ii) shaping the cellulose solution into a desired geometrical shape,

iii) consolidating the shaped cellulose solution into shaped cellulose articles in a coagulation liquid,

iv) releasing or extracting the solvent from the shaped cellulose articles, for example using a non-solvent, preferably water or an aqueous medium, and optionally, washing the shaped cellulose articles.

These are the essential steps. Further details may be obtained from the literature cited above and the following detailed description. As an example, usually, the cellulose solution is shaped by means of extrusion from an extruder and drawing in an air gap between the extruder and the coagulation liquid. Shaping or extrusion is also known as “spinning”, in particular when fibres or filaments are to be obtained as the shaped article. Furthermore, the present invention is not limited to fibres or filaments and all of the aspects of the invention which are described for these shaped articles are also applicable to other shaped articles such as films, nonwovens or hollow tubes.

These described shaped articles and all of the pre-products and intermediate products for these shaped articles in accordance with the process will be described as desired geometrical shapes in the process according to the invention.

Any shaped articles which do not correspond to a desired geometrical shape and which, in the production process for these shaped cellulose articles, cannot be transformed into a desired geometrical shape, will be described as unwanted geometrical shapes in the process according to the invention.

The type of shaped article is frequently determined by the shape and type of the extrusion nozzles and their openings or arrangements. As an example, the desired shape may be filaments which should have a homogeneous thickness, for example with a range of tolerance of ±10% or less.

The recycling of the solvent in accordance with the invention in later steps is independent of this. The shaped cellulose solution may be delivered from the coagulation liquid via a withdrawing device, for example as described in WO 2013/030400 A1. In this regard, the withdrawn coagulated cellulose solution (shaped articles) can be deflected in the coagulation liquid container as shown, for example, in EP 18191628.9.

Particularly during “start-up” or when “starting” the process, increased amounts of shaped article waste, i.e. consolidated or coagulated cellulose solution, accrue in an unwanted shape. During continuous operation as well, waste of this type can always accrue, which results in interruptions to the removal of the (desired) shaped cellulose articles. The shaped article waste (with the unwanted shape) is usually collected, for example in a container such as a basket, then comminuted, for example in a comminutor. Solvent can then be extracted from the comminuted shaped article waste. Extraction may be carried out by washing or mechanical crushing or kneading, preferably by a combination of washing with crushing or kneading of the comminuted shaped article waste. Crushing or kneading can be carried out in a screw, for example, which at the same time can also comminute the shaped article waste.

For these steps, the invention also provides a device for regenerating a solvent for cellulose in a process for the production of shaped cellulose articles. This may comprise a dope production unit, a dope filtration unit, a spinning unit with an extruder, extrusion pumps, heat exchanger, extrusion tools, spinnerets, a container for coagulation liquid which is disposed downstream of a gap below the extruder, or extrusion means, preferably spinnerets, a withdrawing device, a cutting device, a solids collecting container for consolidated shaped cellulose articles, a comminutor for consolidated shaped cellulose articles, a mechanical separating unit for separating solids in liquids, a unit for ion exchange, a unit for concentrating the aqueous cellulose solvent or combinations thereof. Preferably, the device comprises a spinning unit with an extruder, a container for coagulation liquid which is disposed downstream of the gap below the extruder, and a device for withdrawing consolidated shaped cellulose articles from the container. These parts of the device will be explained in more detail below.

Preferably, a solids collecting container for consolidated shaped cellulose articles and a comminutor for comminuting consolidated shaped cellulose articles is provided. The device may furthermore have an extractor for extracting the solvent from the shaped article waste. Similarly, a washing unit for shaped articles (also for waste, but in particular for desired shaped articles) may be provided.

The cellulose solutions provided for extraction are usually initially produced from a suspension in a mixer, for example as described in WO 2009/098073 A1, WO 2011/124387 A1 or U.S. Pat. No. 5,948,905. Usually, cellulose is obtained from wood or wood pulp, but other sources are possible.

The cellulose is comminuted and then mixed with a solvent and water. Subsequent to the continuous suspension production, a portion of the water is removed from the suspension under vacuum and with increased temperature. As soon as the water content has been dropped sufficiently, the cellulose dissolves in the solvent and forms a solution which is suitable for the shaping process (also known as the spinning solution or extrusion solution), which is filtered and then shaped, for example pressed through the extruder (for example spinnerets) during fibre production. The shaped articles shaped in this manner are then precipitated in a bath with coagulation liquid (usually water or water with solvent below the concentration required for the dissolution). In accordance with the invention, non-derivatised cellulose is preferably used (lyocell), i.e. no viscose. Even in the production of the extrusion solution, the formation of waste may occur, which collects in the filters, for example. A filter is described, for example, in WO 2014/085836 A1. Waste of this type may be solid (cellulose suspension or consolidated solution) or liquid (cellulose solution, for example when rinsing the filters).

The solvent (also termed the “solubilizing agent” or “cellulose solvent”) is an agent for dissolving cellulose. Usually in this regard, high temperatures are used, for example 70° C. or more, in particular 75° C. or more or 78° C. or more. In most cases, it is mixed with a non-solvent, i.e. a substance which cannot dissolve cellulose, whereupon the mixture is still suitable for dissolving cellulose. In this regard, inter alia, high proportions of the solvent are necessary in the mixture, e.g. 60% (% by weight) or more—depending on the solvent, this may vary and the proportion can readily be determined by a person skilled in the art by means of dilution experiments.

An extrusion medium for the shaping process is used as a cellulose solution in the process accordance with the invention. The cellulose concentration is selected to be that which is usual for the lyocell process. In this manner, the cellulose concentration in the cellulose solution (provided in step i)) may be 4% to 23%, preferably 6% to 20%, in particular 8% to 18% or 10% to 16% (all proportions given as % by weight).

Preferably, the solvent is a tertiary amine oxide (amine N-oxide), particularly preferably N-methylmorpholine N-oxide.

Alternatively or in addition, it may be an ionic solvent. Examples of ionic solvents of this type have been described in WO 03/029329; WO 2006/000197 A1; Parviainen et al., RSC Adv., 2015, 5, 69728-69737; Liu et al., Green Chem. 2017, DOI: 10.1039/c7gc02880f; Hauru et al., Zellulose (2014) 21:4471-4481; Fernandez et al., J Membra Sci Technol 2011, p:4; etc. and advantageously contain organic cations such as, for example, ammonium, pyrimidium or imidazolium cations, preferably 1,3-dialkylimidazolium salts such as halides, Here, water is also advantageously used as a non-solvent for cellulose. Particularly preferably, a solution of cellulose and butyl-3-methyl imidazolium (BMIM), for example with chloride as the counter-ion (BMIMCl), or 1-ethyl-3-methyl imidazolium (also preferably as the chloride, acetate or diethylphosphate) or 1-hexyl-3-methyl imidazolium or 1-hexyl-1-methyl pyrrolidinium (preferably with a bis(trifluoromethylsulphonyl)amide anion), and water. Other ionic solvents are 1,5-diazabicyclo[4.3.0]non-5-enium, preferably as the acetate; 1-ethyl-3-methyl imidazolium acetate, 1,3-dimethyl imidazolium acetate, 1-ethyl-3-methyl imidazolium chloride, 1-butyl-3-methyl imidazolium acetate, 1-ethyl-3-methyl imidazolium diethylphosphate, 1-methyl-3-methyl imidazolium dimethylphosphate, 1-ethyl-3-methyl imidazolium formate, 1-ethyl-3-methyl imidazolium octanoate, 1,3-diethyl imidazolium acetate and 1-ethyl-3-methyl imidazolium propionate.

Liquids or solids with solvents accrue in various stages of the lyocell process (or the like). The solvent has to be collected, extracted and/or regenerated from them, so that the solvent can again serve to dissolve cellulose for the lyocell process. In this regard, the solvent does not have to be obtained as a pure substance. A mixture of solvent and non-solvent which is suitable for dissolving cellulose is sufficient. Concentration of the solvent of this type may also be seen as part of the regeneration of the solvent. The aim is to leave the solvent in the process as much as possible and to avoid losses. In particular, the aim is to keep over 99%, in particular over 99.5% (all as a % by weight) of the solvent in the process.

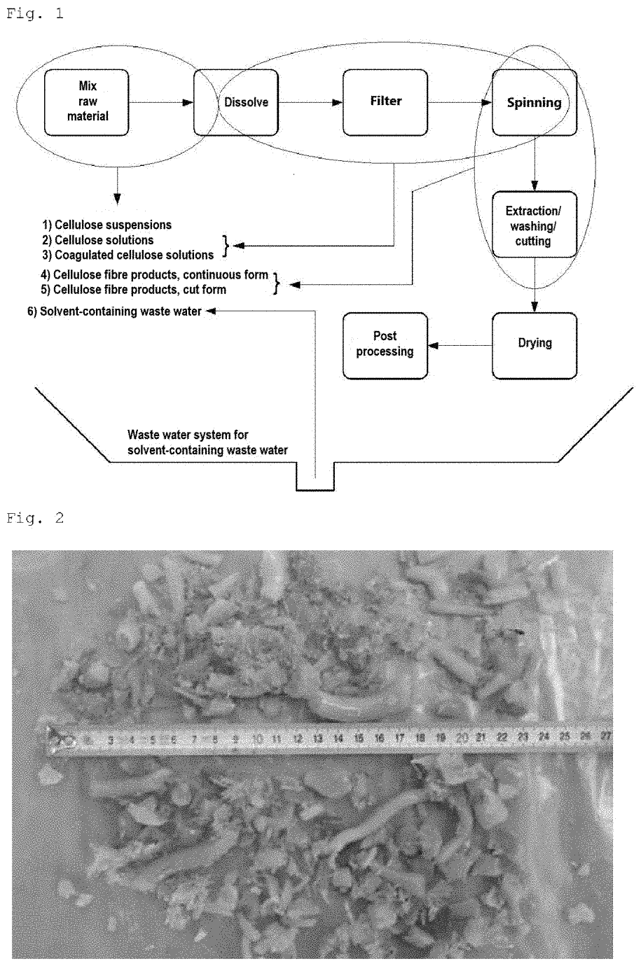

Particular solvent-containing substances are (see FIG. 1):

(1) cellulose suspensions, for example formed from residues from cellulose production,

(2) cellulose solutions, for example from filters,

(3) coagulated cellulose solutions, for example shaped article waste in an unwanted shape which in particular accrues during start-up of the process,

(4) shaped cellulose articles in a continuous form, for example after shaping, which are washed in order to extract solvent from them,

(5) shaped cellulose articles in the cut form, for example after shaping and cutting, which are washed in order to extract the solvent therefrom,

(6) solvent-containing waste water which accrues in various stages, for example as a coagulation liquid which is discharged from the coagulation liquid container with the shaped articles, spraying liquids, washing liquids (when lashing the desired shaped articles), extraction liquids from the treatment of the solid waste. Losses of this type occur, for example, when they drain out of the shaped articles. In order to prevent or minimize this, a collecting basin to collect these losses may be provided. This can also be implemented in the form of a network of channels separated from the non-solvent-containing waste, limited to both the washing region and also to the entire region of the process in which the solvent is used.

All of the shaped cellulose articles described in (1) to (5) may be present both in the desired shape (for example as regular shaped articles, during fibre production) and also in an unwanted shape (for example as waste material). The distinction between product and waste may be set arbitrarily, depending on the quality criteria for the desired product (as a rule, clumps which interrupt the process are always considered to be waste) or set according to the economics of the process (offcuts). The process in accordance with the invention is advantageously characterized by the following features:

Preferably, the solid waste is collected from (1) cellulose suspensions, (2) cellulose solutions, (3) coagulated cellulose solutions, for example shaped article waste in the unwanted shape, (4) shaped cellulose articles in the continuous form—if present as waste, (5) shaped cellulose articles in the cut form—if present as waste, with the aim of carrying out combined further treatment. As long as no solids are discarded from (4) and (5), the extraction and/or washing liquid from their treatment can be collected.

Optionally, the tackiness, for example of the cellulose suspension (1), can be reduced by treatment with non-solvent, for example water, prior to further processing (in particular comminution).

Processing solid waste can result in liquid waste and processing liquid waste may lead to solid waste. In this regard, solvent is washed, extracted or leached out of solid waste. The solvent-containing liquids that arise in this regard (washing or extraction liquids) are conveyed to the regeneration as liquid waste. Liquid waste with a sufficiently high cellulose content can be precipitated (for example from (2), for example as described in CN 104711706), and thus result in solvent-containing solid waste which in turn is fed to the solid preparation in accordance with the invention in order to wash solvent out of it or to extract it (which in turn results in liquid waste). The solid will only be disposed of when sufficient or almost all of the solvent has been removed. This is also the case for liquids or fluids without solvent (for example water vapour from evaporation to concentrate the solvent in the remaining liquid), which can be disposed of or otherwise used in the lyocell process.

The solid solvent-containing waste may have a variety of forms. If it is precipitated from cellulose suspensions or solutions prior to shaping (for example in a filter) , cellulose can be eliminated from these media (by mixing with non-solvents and/or cooling). This usually results in fine fibrous waste. During shaping, clumps may occur, in particular when starting or running-up the continuous extrusion procedure. Preferably, shaping of the cellulose solution into a desired geometrical shape is spinning into strands or filaments. In this regard, the shaped article waste may be in the unwanted form of clumps of the strands or filaments.

Other solid waste is constituted by cut waste from the shaped articles, even that which was initially in the desired shape.

In accordance with the invention, various types of shaped article waste from these various sections of the process may be mixed. Preferably, solid solvent-containing waste from coagulated cellulose solutions or suspensions prior to shaping are mixed with shaped article waste following shaping, for example the clumps or in fact shaped articles in the desired shape. Mixing means that the efficiency of the comminution is increased, i.e. the solid waste provided for comminution is easier to process and thus more quickly reaches the desired comminuted size, or fewer interruptions or clumps occur in the comminutor. In particular, shaped articles in the desired shape, such as cellulose fibres, are often difficult to comminute. The concentration of these fractions is reduced by mixing with other solid waste, whereupon the comminutor can handle the mixed waste more easily. Mixing ratios of two parts of shaped cellulose article waste (depending on the shape, preferably with waste in the desired shape) to one or more parts of solid waste prior to shaping, i.e. which accrues prior to shaping (from cellulose suspensions or cellulose solutions), have a positive effect due to more efficient comminution. Mixtures of one part shaped cellulose article waste to two or more parts solid waste which accrues prior to shaping is particularly preferred and has been shown to be particularly efficient. The collected solid waste is treated with a comminution apparatus in order to reduce the grain size. In this regard, the collected solid waste can be treated separately (for example after separation or sieving), or the collected solid waste can be treated in combination. In this regard, the solid waste treated in combination may be specifically treated as a mixture, or the solid waste treated in combination may be specifically treated in sequence.

The comminution may be carried out in a single stage or in multiple stages (by means of pre-comminutors and/or post-comminutors).

Preferably, comminution in step C) is carried out with a cutting mill. In accordance with the invention, it has been shown that a mill with a cutting element is particularly suitable for comminuting shaped article waste and also other solid solvent-containing waste without introducing too much frictional energy so that the solid medium heats up significantly. At the same time, the point mechanical forces acting through the cutting element are high enough to comminute even tough and fibrous waste.

Preferably, the cutting element acts against a counter-cutting piece such as a stator or a further cutting element, so that the waste is cut between the elements, Comminution by cutting is preferred. Particularly preferably, the cutting mill has a rotor with protruding cutting elements as well as a sieve with openings, wherein the cutting elements interfere with the sieve openings. The sieve acts as a counter-cutting piece with counter-cutting edges, and because the cutting elements penetrate into the openings, solid waste that is located in them is comminuted and can be pushed through the openings. The openings may be in a stator or alternatively in a further rotor shaft. Other sieves may be used in order to control the grain size of the comminuted material. As an example, a sieve could control the transport of material away. Only material which passes through sieve openings is transported away; coarser material remains within range of the cutting elements and is comminuted further. In accordance with the invention, it has been shown that by means of a sieve of this type, particularly efficient comminution of cellulose waste from the lyocell process is possible.

A comminutor with a rotor with one or more protruding cutting elements and one or more counter-cutting edge(s) is particularly preferred, wherein the cutting elements slide past the counter-cutting edges so that shaped articles or shaped article waste between the cutting elements and the counter-cutting edges is comminuted. Preferably, the cutting edges and/or the counter-cutting edge are toothed. The tip of the tooth is preferably formed by edges at an angle of 160° to 30°. Preferably, a sieve is provided close to and/or below the rotor in order to control the size of the cut material, More preferably, the rotor is equipped with protruding frictional elements or one or more cutting elements and one or more counter-cutting edge(s), wherein the cutting elements slide past the counter-cutting edges so that shaped articles or shaped article waste between the cutting elements and the counter-cutting edges are comminuted. The shaped articles or shaped article waste can be conveyed continuously or discontinuously to the cutting elements for comminution. Particularly preferably, the cutting elements are triangular or toothed in shape. More preferably, the frictional or cutting elements are attached to the rotor in a manner which is offset with respect to each other.

These preferred elements, and in particular their combination, results in an extremely suitable process, An example of a comminutor of this type is the “Antares” shredder from Lindner Recyclingtech GmbH, which was originally developed for the comminution of wood. Surprisingly, it is suitable for optimized comminution of the paste-like solid waste from the lyocell process.

Preferably, the shaped articles and other solid waste (even that prior to shaping) are comminuted to a size (maximum dimensions of the particle) of 20 mm or less, preferably 15 mm or less. Exemplary sizes are 10 mm to 20 mm.

Optionally, a post-comminutor may be used, which comminutes the shaped articles and other solid waste to a size of 10 to 15 mm or less, preferably 10 mm or less. The post-comminutor may be configured in a similar or identical manner as the pre-comminutor, apart from the dimensions of the comminution.

Preferably, in the comminution step, water or an aqueous medium is fed to the comminutor. In this regard, an extraction or release of cellulose solvent from the shaped articles may also take place in the comminutor.

Further advantageous features of the comminutor are discussed below in part (b), “Comminution of waste materials”, in particular with reference to FIGS. 6-9, The comminuted solids are introduced directly into an extraction container (for example a tank). Alternatively, the comminuted solids may be stored temporarily. Preferably, all of the comminuted solids, irrespective of the original location where it occurs, i.e. (1) to (5) , are fed together to an extraction container (for example a tank).

Preferably, the extraction is carried out with stirring, for example using a stirrer, The solid-liquid mixture is conveyed with a pump for dewatering.

The dewatering and extraction may be carried out in combination, in stages. This can be undertaken in one or more extraction and dewatering stages. Preferably, water is used for the extraction. Preferably, during the extraction, the non-solvent required, for example water, is fed as a counter-current to the solid-liquid mixture which is to be treated.

Preferably, all of the liquid waste is collected in order to be processed further in the process in accordance with the invention.

Liquid containing solvent accrues in various steps and may be combined for processing. Preferably, coagulation liquid is separated from the shaped cellulose articles from step A) iii) after transporting out of a container with coagulation liquid, for example by draining or pressing the shaped cellulose articles, and is collected together with extracted solvent from step D).

In addition, the device in accordance with the invention has a channel (for example open trough or closed pipe) at the bottom for collecting and transferring coagulation liquid removed from the spinning unit which is fed into a liquid collecting container or an evaporator for cellulose solvent-containing liquids. This channel is preferably covered with a cover that can be walked on but is permeable to liquids so that contact of operational personnel of the lyocell plant with the solvent-containing liquid is minimized. An example of a cover of this type is a grating.

In accordance with the process in accordance with the invention, the liquid waste is processed further in a manner such that the solvent contained in it can be recovered in its original purity—or at least in a purity which is sufficient for the lyocell process—, and thus can be returned to the process.

Preferably, the liquid waste is collected in a vessel so that it can undergo this process as a combination. The aim is to recycle the solvent to the lyocell process as completely as possible.

In a first step, the liquid waste may be filtered in order to remove solid residues (US 2011/0226427 A1) and/or to be transferred for ion exchange in order to remove harmful ions, for example iron or copper ions (see, for example, Han et al., Journal of Textile Research 29(6), 2008, 15-19). NMMO degradation products such as NMM (N-methyl morpholine) can be decolorized by oxidation or regenerated into NMMO. A suitable process for oxidation is described in WO 2018/115443 A1.

An efficient preparation of solvent-containing liquids is obtained in accordance with the invention by combined further processing (for example purification, in particular concentration of the solvent). Preferably, in accordance with the invention, concentration of the solvent is carried out by means of the solvent-containing washing liquids from step A) iv) and the solvent-containing extraction liquids from step D)—i.e. after washing, separation or extraction. In addition, in the device in accordance with the invention, evaporators, micro- or ultrafiltration processes, membrane or osmotic separation methods and/or crystallization apparatus may be provided. In this regard, these processes may also be used in combination or sequentially. In this regard, the process in accordance with the invention also enables a selective use in which the defined solvent-containing waste water stream is pre-treated in a process and afterwards is fed in combination to a further concentration stage.

Preferably, the extracted solvent or aqueous solvent mixture undergoes a mechanical separation process prior to concentration. A mechanical separation enables the separation of other phases such as a solid phase. An example of a separation process of this type is filtration or adsorption.

The mechanical separation process may be carried out as a static and/or dynamic filtration. In a static filtration, a phase to be separated (retentate) is kept static, for example in a filter or fixed to or immobilized on an adsorbent. Preferred static filtration methods are (over) pressure filtration, vacuum filtration, surface filtration, layer filtration, in particular deep filtration, for example with sand filters.

The mechanical separation method may also or alternatively be carried out as a dynamic filtration. A dynamic filtration has two mobile phases which are separated by a membrane, for example. An example is membrane filtration, preferably as a cross flow filtration or tangential flow filtration. In this regard, both mobile phases are usually fluids, in particular liquids. The membrane technology for processing solvents, in particular NNMO and/or ionic liquids, is described, for example, in “Recovery of ionic liquids from wastewater by nanofiltration” (Journal of Membrane Science and Technology 2011, pages 4-8; DOI:10.4172/2155-9589.p4-001 and in EP 0 448 924 (both incorporated herein by reference). This technology is used in the invention as a preference.

The preferred filtration method is preferably dynamic filtration, microfiltration, ultrafiltration, nanofiltration or reverse osmosis. Usual pore sizes for the filter or membrane for this filtration method are 0.5-0.1 μm for microfiltration, 0.1-0.01 μm for ultrafiltration, 0.01-0.001 μm for nanofiltration, 1-0.1 nm for reverse osmosis.

Phases to be separated may also be separated without filtration, for example by settling or centrifuging, in particular in order to remove solids. In this regard, preferably in the process in accordance with the invention, the released or extracted solvent or aqueous solvent mixture is fed to a settling tank prior to enrichment. More preferably, the released or extracted solvent or aqueous solvent mixture is fed to a centrifuge and/or separator prior to concentration. Furthermore, the released or extracted solvent or aqueous solvent mixture may be fed to a filter press prior to concentration. Furthermore or as an alternative, the released or extracted solvent or aqueous solvent mixture may be fed to a centrifuge and/or separator prior to concentration in order to obtain therein a further separation of contaminating material such as solids.

Preferably, a combination of a settling tank, a filter press, a centrifuge and/or a separator is used.

Particularly preferably, the released or extracted solvent or aqueous solvent mixture is treated with a rotary microfilter prior to concentration.

In all of the embodiments, the extraction and/or filtration step may be carried out discontinuously and/or continuously.

Afterwards, the solvent or aqueous solvent mixture preferably undergoes an ion exchange, for example by means of an ion exchanger. In this regard, for example, after the (discontinuous and/or continuous) extraction and/or filtration step, the solvent or aqueous solvent mixture is fed to a cation and/or anion exchanger.

These concentration steps may be undertaken in order to obtain dissolution of the cellulose solvent which is suitable for dissolving or suspending cellulose. Preferably, a concentration of at least 50% (% by weight), particularly preferably 50% or more or 70% or more, of solvent in the solution, in particular in the case of N-methyl morpholine N-oxide as the solvent, is obtained. Dissolution or suspension, for which the concentrated solution is suitable, are early steps in the lyocell process—as described above. In brief, cellulose is suspended with a solvent-non-solvent mixture and taken up into solution by removing non-solvent. The quantities of the usual solvents in this mixture are 50% or more, for example 58% to 78% (all as % by weight). Cellulose solutions may, for example, essentially contain 5-16% cellulose, 55-80% of solvent, in particular NMMO, and the remainder, preferably 18-30%, of non-solvent, in particular water (all as a % by weight). Negligible trace components such as salts are not taken into consideration in this regard.

Concentration preferably comprises evaporation of non-solvent, which is preferably water. Evaporation is a preferred implementation with amine oxides, in particular NMMO, as the solvent. Alternatively or in addition, concentration of the solvent may comprise crystallization. This is particularly preferred in the case of ionic solvents. The device in accordance with the invention may contain a concentrating device, in particular an evaporator to evaporate non-solvent from cellulose-solvent-containing liquids (U.S. Pat. No. 8,932,471; US 2011/0226427 A1), or a crystallization unit (Liu et al., see above).

The device in accordance with the invention can thus be used for the production of cellulose suspensions in aqueous solvents and/or for the production of cellulose solutions in aqueous solvents.

The invention furthermore concerns a cellulose product which has been obtained with a process in accordance with the invention, in particular through the use of a purified, concentrated aqueous solvent. The cellulose product is obtained by extrusion of the cellulose solution (shaping, as described herein).

The cellulose product is preferably a continuous cellulose filament product or a cellulose staple fibre product, or a cellulose film product. Before or after concentration, the solvent-containing liquid may be purified by ion exchange. To this end, a cation and/or anion exchanger is used, in particular in order to remove iron and copper ions from the liquid.

Solvent-containing liquid accrues in various steps and can be combined for processing. Preferably, coagulation liquid which drains out or is pressed out from the shaped cellulose articles of step A) iii) after transportation from the container with coagulation liquid, is collected with extracted solvent from step D) and/or is further processed—in particular for the purposes of concentration. The coagulation liquid is in a container during the continuous process. A collecting basin to collect cellulose solvent draining out of the container due to transporting the shaped cellulose articles away may be associated with the container. A line to a common collecting container may lead from this container. In the lyocell process, a cellulose solution is shaped, for example by extrusion or spinning, and is introduced into the coagulation liquid. This brings about an exchange of solvent between the shaped cellulose solution and the coagulation liquid. The shaped articles shaped in this manner are in turn taken out of the coagulation liquid, whereupon various losses of the solvent-containing coagulation liquid may occur. These losses are avoided, for example, by collecting liquid that has drained out. As an example, after removal from the container containing coagulation liquid, a withdrawal unit may be provided in which the shaped articles are deflected around one or more rollers and drawn off. Solvent-containing liquid which drains off can be collected here.

The steps A) i) to iv) are carried out in one or more spinning unit(s). Each unit has an extruder which feeds the cellulose solution into separate or joint coagulation liquid containers. Preferably, a plurality of spinning units are combined, as shown in WO 02/12599 A1, for example. Preferably, the coagulation liquid discharged from the spinning unit is collected via a channel and is mixed together with the solvent from step D) and processed further together, in particular for concentration. More preferably, the solvent-containing aqueous coagulation liquid discharged from the spinning unit is collected via a channel or a channel system and mixed together with the solvent or aqueous solvent mixture from step iv), is sent for purification, concentration and recycling. Solvent spraying losses from a unit can arrive at the bottom. From here, solvent-containing liquid is collected via a channel and transferred. The device in accordance with the invention has a channel for this purpose (for example an open trough or closed pipe) at the bottom for collecting and transferring coagulation liquid discharged from the spinning unit, which leads into a liquid collecting container or an evaporator for cellulose solvent-containing liquids. This channel is preferably covered by a cover which can be walked on but is permeable to liquids, so that contact of personnel operating the lyocell unit with the solvent-containing liquid is minimized. An example of a cover of this type is a grating.

The present invention will now be further explained by means of the embodiments described below.

FIG. 1 shows locations where solvent-containing waste accrues in the lyocell process. The lyocell process is roughly divided into the steps of raw material mixing, dissolution of cellulose, filtration, spinning (or, in general, shaping), extraction of solvent/washing of shaped articles/cutting the shaped articles, drying the shaped articles and further processing (such as rolling up, crimping, etc)—depending on the processing path from the cellulose starting material (such as wood pulp) to the finished shaped articles, The waste in these individual steps is labelled and listed. A basin with a channel is outlined below the diagram, which encompasses collection of the solvent-containing waste water (in particular because the collecting basins and collection channels are used in order to collect the waste water). The solvent-containing products and waste are therefore: (1) cellulose suspension, (2) cellulose solutions, (3) coagulated cellulose solutions, (4) shaped cellulose articles in a continuous form, (5) shaped cellulose articles in a cut form, (6) solvent-containing waste water.

(1) Cellulose Suspensions

Cellulose suspensions are mixtures with the main components being cellulose, water and a solvent, for example N-methyl morpholine N-oxide (NMMNO). Furthermore, stabilizers and other substances which are important to the process are added. Cellulose suspensions occur as a waste product in the region of the unit for mixing raw materials and also during the dissolution procedure. Possible cellulose suspension compositions are shown in Table 1.

TABLE 1
Examples of cellulose suspensions
with different compositions

| | | | |
|---|---|---|---|
| | Cellulose | NMMNO | Water |
| | concentration | concentration | concentration |
| Symbol | c_Cell | c_NMMNO | c_H2O |
| Unit | [wt %] | [wt %] | [wt %] |
| Letter | a | b | c |

Example no.

| | | | |
|---|---|---|---|
| 1 | 5.7 | 75.3 | 19.0 |
| 2 | 6.5 | 69.2 | 24.3 |
| 3 | 7.7 | 71.1 | 21.2 |
| 4 | 8.3 | 71.0 | 20.7 |
| 5 | 9.0 | 69.7 | 21.3 |
| 6 | 10.0 | 64.3 | 25.7 |
| 7 | 10.5 | 59.2 | 30.3 |
| 8 | 10.5 | 61.8 | 27.7 |
| 9 | 10.5 | 65.2 | 24.4 |
| 10 | 10.5 | 67.2 | 22.4 |
| 11 | 10.5 | 69.4 | 20.1 |
| 12 | 11.9 | 64.7 | 23.4 |
| 13 | 12.5 | 62.3 | 25.2 |
| 14 | 13.2 | 61.1 | 25.7 |
| 15 | 15.9 | 58.0 | 26.1 |

(2) Cellulose Solutions

Cellulose is dissolved with the removal of water from the suspension, and thus with concentration of the solvent. Cellulose solutions occur as the waste product in the region of the unit for dissolution, filtration and shaping (for example spinning). Possible cellulose solution compositions are shown in Table 2.

TABLE 2
Examples of cellulose solutions arising
from the given cellulose suspensions.

| | | | |
|---|---|---|---|
| | Cellulose | NMMNO | Water |
| | concentration | concentration | concentration |
| Symbol | c_Cell | c_NMMNO | c_H2O |
| Unit | [wt %] | [wt %] | [wt %] |
| Letter | a | b | c |

Example no.

| | | | |
|---|---|---|---|
| 1 | 6.1 | 80.2 | 13.7 |
| 2 | 7.5 | 79.9 | 12.6 |
| 3 | 8.5 | 78.8 | 12.7 |
| 4 | 9.3 | 79.2 | 11.5 |
| 5 | 10.2 | 78.7 | 11.1 |
| 6 | 12.0 | 77.1 | 10.9 |
| 7 | 13.4 | 75.7 | 10.9 |
| 8 | 12.9 | 76.4 | 10.7 |
| 9 | 12.5 | 78.0 | 9.5 |
| 10 | 12.2 | 78.1 | 9.7 |
| 11 | 11.8 | 78.2 | 10.0 |
| 12 | 14.1 | 76.5 | 9.4 |
| 13 | 15.1 | 75.4 | 9.5 |
| 14 | 16.1 | 74.8 | 9.1 |
| 15 | 19.7 | 71.9 | 8.4 |

(3) Coagulated Cellulose Solutions

The solvent present in the cellulose solution is extracted by adding water and the cellulose precipitates out (coagulation by introducing the cellulose solution into the coagulation liquid). In addition to the main process where this effect is vital to the shaping of the cellulose product, this is also used in order to bind various waste products with water or to reduce its tackiness. Depending on the location in which it accrues and the starting solution, cellulose solutions coagulated in this manner are obtained with very different compositions. Coagulated cellulose solutions occur when processing cellulose solutions from the waste product (2) in the region of the unit for dissolution, filtration and shaping (for example spinning). Possible compositions for the coagulated cellulose solutions are listed in Table 3.

TABLE 3
Examples of cellulose solutions coagulated in water

| | | | |
|---|---|---|---|
| | Cellulose | NMMNO | Water |
| | concentration | concentration | concentration |
| Symbol | c_Cell | c_NMMNO | c_H2O |
| Unit | [wt %] | [wt %] | [wt %] |
| Letter | a | b | c |

Example no.

| | | | |
|---|---|---|---|
| 1 | 6.7 | 62.1 | 31.2 |
| 2 | 7.9 | 51.2 | 40.9 |
| 3 | 14.2 | 57.3 | 28.5 |
| 4 | 22.5 | 32.9 | 44.6 |
| 5 | 6.2 | 75.3 | 18.5 |
| 6 | 12.3 | 70.0 | 17.7 |
| 7 | 12.5 | 74.3 | 13.2 |
| 8 | 16.7 | 63.8 | 19.5 |
| 9 | 13.9 | 64.8 | 21.3 |
| 10 | 11.6 | 55.7 | 32.7 |
| 11 | 24.8 | 40.3 | 34.9 |
| 12 | 28.7 | 16.2 | 55.1 |
| 13 | 22.4 | 29.4 | 48.2 |
| 14 | 17.3 | 15.8 | 66.9 |
| 15 | 16.4 | 19.0 | 64.6 |

(4) Cellulose Fibre Products in Continuous Form

Cellulose fibre products (or in general, shaped articles) in the continuous form are produced in the lyocell process as an intermediate product, and also as the end product.

Waste products in this form occur in the region of the extrusion (spinning) unit, as well as in downstream solvent extraction, washing and product processing (for example cutting). Possible compositions of cellulose fibre products both in the continuous and in the cut form are listed in Table 4.

(5) Cellulose Fibre Products (Shaped Articles) In Cut Form

Shaped cellulose articles in the cut form are produced by the process step for product processing (for example cutting) from continuous shaped cellulose articles (4). The possible compositions of the material match the cellulose fibre products in the continuous form and are listed in Table 4.

After extracting the solvent, in the regular product, no proportion of potentially recoverable solvent can remain in the cellulose fibre product. Solid waste without solvent can be discarded. If solvent remains in the waste after extraction, for example in an exceptional case or in the event of stoppages, these can be processed together with the other solvent-containing solid waste.

TABLE 4
Examples of cellulose fibre products in various
stages of the process. These are valid both for
continuous and for cut cellulose fibre products.

| | | | |
|---|---|---|---|
| | Cellulose | NMMNO | Water |
| | concentration | concentration | concentration |
| Symbol | c_Cell | c_NMMNO | c_H2O |
| Unit | [wt %] | [wt %] | [wt %] |
| Letter | a | b | c |

Example no.

| | | | |
|---|---|---|---|
| 1 | 15.4 | 43.0 | 41.6 |
| 2 | 17.3 | 27.9 | 54.8 |
| 3 | 19.4 | 22.4 | 58.2 |
| 4 | 22.1 | 14.3 | 63.6 |
| 5 | 20.4 | 10.9 | 68.7 |
| 6 | 21.4 | 5.4 | 73.2 |
| 7 | 21.8 | 2.1 | 76.1 |
| 8 | 26.3 | 1.2 | 72.5 |
| 9 | 28.0 | <1 | 72.0 |
| 10 | 38.4 | <1 | 61.6 |
| 11 | 43.8 | <1 | 56.2 |
| 12 | 53.7 | <1 | 46.3 |
| 13 | 56.9 | <1 | 43.1 |
| 14 | 53.4 | 3.0 | 43.6 |
| 15 | 42.6 | 9.7 | 47.7 |

(6) Solvent-Containing Waste Water

Solvent-containing waste water can occur intentionally or unintentionally in very different regions of the units of the lyocell process. The specific collection and recycling of this waste water is an essential component of the solvent circuit and is carried out consistently in order to guarantee a high recovery rate for the solvent.

Thus, in the regions of the units of the lyocell process where solvent-containing waste water may occur, special demands are made of the waste water and channel network in order to specifically collect this waste water. Affected regions of the units are made fluid-tight, for example by means of sealing and resistant concrete, or special floor coatings.

The major sources of the solvent-containing waste water are the backwashing and regeneration procedures of the filtration and cleaning steps for the cellulose solution and the solvent in the process. Other sources are the cleaning procedures in the production unit and the solvent-containing waste water produced during recovery of the solvent from solid waste.

Various possible compositions for sub-streams of the solvent-containing waste water are shown in Table 5.

TABLE 5
Examples of solvent-containing waste water with or
without solid loading. The solid usually consists of
cellulose, hut this is not always the case, particularly with
waste water produced from cleaning unit components

| | | | |
|---|---|---|---|
| | Solids | NMMNO | Water |
| | concentration | concentration | concentration |
| Symbol | c_Solids | c_NMMNO | c_H2O |
| Unit | [wt %] | [wt %] | [wt %] |
| Letter | a | b | c |

Example no.

| | | | |
|---|---|---|---|
| 1 | 0.0 | 83.4 | 16.6 |
| 2 | 0.0 | 53.4 | 46.6 |
| 3 | 0.0 | 45.7 | 54.3 |
| 4 | 0.0 | 24.6 | 75.4 |
| 5 | <1 | 26.7 | 73.3 |
| 6 | <1 | 22.4 | 77.6 |
| 7 | <1 | 14.3 | 85.7 |
| 8 | 0.0 | 12.4 | 87.6 |
| 9 | <1 | 10.2 | 89.8 |
| 10 | 0.0 | 3.4 | 96.6 |
| 11 | 0.0 | 1.5 | 98.5 |
| 12 | 3.4 | 10.5 | 89.5 |
| 13 | 6.7 | 12.4 | 87.6 |
| 14 | <1 | <1 | 99.0 |
| 15 | 0.0 | <1 | 100.0 |

In accordance with the invention, when recycling the solvent to the lyocell process, the efficiency is improved by upgrading and processing different types of solvent-containing residual materials and waste materials and waste water.

In accordance with the invention, a process is disclosed which provides the following steps for the preparation of waste materials or residual materials as well as mixtures of residual materials and waste water:

(a) Collecting the solid solvent-containing waste materials (for example as cited above as (1) to (5)). These waste materials may be further processed separately or after bringing together some or all of the waste materials (1) to (5).

(b) Comminuting the waste materials cited in (a). Because water is used in this step, then here again, a portion or all of the solvent can be extracted and this extraction liquid can be fed to the solvent preparation. These waste materials (1) to (5) can be comminuted separately or together.

(c) Extracting the cellulose solvent from the comminuted waste materials or mixtures of materials, preferably in a common process which can be used in an identical manner for all solid waste materials (1) to (5).

(d) Dewatering the residual solids extracted in (c), with optional subsequent rinsing and cleaning thereof. Steps (c) and (d) of the process can in this regard be repeated as many times as desired until the desired residual solvent content is obtained in the residual solid. This solid is finally discarded from the process as a waste product.

(e) Collection and cleaning of all solvent-containing waste water. This comprises both the waste water produced in (a) to (d) and also the entirety of the solvent-containing waste water (6) collected in the lyocell unit. Depending on the degree of contamination of the waste water, this may be freed from solid contamination separately in one or more filters. Preferably, the entire collected solvent-containing waste water is cleaned together in one or more fine filtration stages.

(f) The waste water filtered in step (e) of the process is fed over a cation and anion exchanger in order to remove ionic contamination which perturb the lyocell process (such as iron or copper ions).

(g) The clean solvent-containing waste water from step (f) of the process is fed to a concentration unit where the solvent concentration is again raised to the original concentration used in the lyocell process.

Because the solvent recycle rate is raised so effectively, the process in accordance with the invention is extremely eco-friendly and contributes to the economic viability of the lyocell process.

(a) Collection of Waste Materials

The waste cited under (1) to (5) is accrued at different locations, as can be seen in FIG. 1, and as described, has different properties. In order to prepare these waste materials for the next step (b) of the process, a plurality of optional process steps may be employed:
Production of coagulated cellulose solutions (3) from the cellulose solutions (2) by wetting or immersion with non-solvents, preferably water. This prevents tackiness of the materials and facilitates transportation.
Cooling the waste products ((1), (2) and (3)), which are usually hot, with cooled water. This helps to solidify the media and facilitates comminution.
Coarse separation of inorganic and organic residual materials, in case inorganic or metallic impurities are present in the mixture.
Portioning the waste product in easily transportable containers. This enables easy temporal decoupling between discontinuous waste production and continuous waste processing. Furthermore, this decoupling allows for systematic selection of the comminution sequence in the next step of the process.
Mixing the shaped cellulose article waste products, in particular fibres ((4) and (5)), with solution waste products ((2) and (3)), either directly in the context of collection or by an alternative input into the comminution step (b) of the process.

The aim of mixing is to increase the comminution action of the comminution apparatus for components which are difficult to comminute such as cellulose fibre waste products, for example. The mixing ratios of two parts cellulose fibre waste products ((4) and (5)) to one or more parts of solution waste products ((2) and (3)) have a positive effect on more efficient comminution. Mixtures of one part cellulose fibre waste products to two or more parts of solution waste products is particularly preferred.

The quantities of the various waste products (1) to (5) that accrue are heavily dependent on the type of unit and the cellulose product produced. Examples of a possible distribution of waste products in a cellulose staple fibre process are shown in Table 6 and Table 7.

The collection and storage of the waste materials takes place in any transportation containers. No special requirements are specified for the equipment employed.

TABLE 6
Daily quantities of waste in normal operation
with respect to a normal hourly production
(NHP) of dope in a production line.

| | | Min | Max | Expected |
|---|---|---|---|---|
| | | waste | waste | waste |
| | | quantity with | quantity with | quantity with |
| | | respect to | respect to | respect to |
| Media | | % NHP | % NHP | % NHP |
| Cellulose | (1) | 0 | 10 | 0 to 5 |
| suspensions | | | | |
| Cellulose | (2) | 0 | 50 | 5 to 15 |
| solutions | | | | |
| Cellulose | (3) | 0 | 30 | 3 to 8 |
| solutions, | | | | |
| coagulated | | | | |
| Cellulose | (4) | 0 | 5 | 0.3 to 0.8 |
| fibres, | | | | |
| continuous | | | | |
| Cellulose | (5) | 0 | 5 | 0 to 0.5 |
| fibres, cut | | | | |

TABLE 7
Daily quantities of waste in start-up operation
with respect to a normal hourly production
(NHP) of dope in a production line.

| | | Min | Max | Expected |
|---|---|---|---|---|
| | | waste | waste | waste |
| | | quantity with | quantity with | quantity with |
| | | respect to | respect to | respect to |
| Media | | % NHP | % NHP | % NHP |
| Cellulose | (1) | 10 | 100 | 20 to 50 |
| suspensions | | | | |
| Cellulose | (2) | 100 | 400 | 150 to 200 |
| solutions | | | | |
| Cellulose | (3) | 100 | 400 | 100 to 150 |
| solutions, | | | | |
| coagulated | | | | |
| Cellulose | (4) | 1 | 20 | 3 to 8 |
| fibres, | | | | |
| continuous | | | | |
| Cellulose | (5) | 1 | 5 | 1 to 2 |
| fibres, cut | | | | |

(b) Comminution of Waste Materials

The comminution of the waste materials cited in (a) is carried out separately or after combining some or all of it,

The comminution of the waste materials may be carried out in one or more steps, with the aim of obtaining a final grain size in the range between 5 and 15 mm, in order to obtain a sufficiently large surface area for the subsequent extraction process.

The following steps of the process have been shown to be advantageous for the comminution:
The comminutor carries out thorough mixing of the residual waste at the same time. Mixing the various types of waste as described in (a), Collection of the waste materials, increases the comminution effect for cellulose fibre waste.
Pre-comminution to a grain size for the waste of less than 50 mm, preferably less than 30 mm, in particular less than 20 mm, may be carried out by means of a slow running comminutor in a particularly energy-efficient and operationally safe manner. An example of the material produced in this regard is shown in FIG. 2.

This process with a slowly rotating rotor shaft is of particular advantage, because these tools introduce only a little frictional energy, and thus the waste materials are not thermally compromised, which could result in degradation of the NMMO and the risk of fire.
During comminution, aqueous solvent or pure water may be added to the waste product so that even during enlargement of the surface area, coagulation of the waste materials is carried out and the cellulose solvent is already being extracted in the comminution step.

A post-comminution with a fast running cutting tool, for example a cutting mill, can reduce this pre-comminuted material particularly efficiently to a target grain size of between 2 and 15 mm, preferably approximately 10 mm. This post-comminution can also be carried out in a wet medium, wherein a cutting pump may be used in order to pump the extraction water flow together with the solid material through the cutting means. This type of feeding of the medium is particularly advantageous because the flow of water has a cooling effect at the same time, but simultaneously has a solvent extraction action (step (c) of the process).

For pre-comminution, particularly slow-running shredder tools are suitable such as, for example:
GSL Slow Speed Granulator from ZERMA Zerkleinerungsmaschinenbau GmbH
ZPS Single Shaft Shredder from AMIS Maschinen-Vertriebs GmbH
ANTARES Single Shaft Shredder from Lindner Recyclingtech GmbH
M&J FineShred from Metso Waste Recycling.

For post-comminution, particularly fast-running shredder tools are suitable such as, for example:
ALPINE Rotoplex cutting mill from Hosokawa Alpine AG
CS-Z fine cutting mill from Netzsch Lohnmahltechnik GmbH. Hammer mills (for example for pre-comminution):

CEMTEC Cement and Mining Technology GmbH; Gebr. Jehmlich GmbH; J. Rettenmaier & Sohne GmbH+Co. KG; MINOX Siebtechnik GmbH SIEBTECHNIK GmbH;

Granulators, tearing machines, grating mills:

Alexanderwerk GmbH; AMIS Maschinen Vertriebs GmbH; Automatik Plastics Machinery GmbH; BKG Bruckmann & Kreyenborg; Coperion GmbH; Dreher GmbH & Co KG, ECON GmbH; EREMA Ges.m.b.H. Gala K.+K.-Maschinen GmbH; Getecha GmbH; HB-Feinmechanik GmbH & Co. KG; Herbold Meckesheim GmbH; HOSOKAWA Alpine AG, Lindner Recycling Tech; Nordson XALOY Europe GmbH; Noris Plastic GmbH & Co. KG; Pallmann Maschinenfabrik GmbH & Co. KG; Plasma GmbH; Reduction Engineering GmbH; Rolf Schlicht GmbH; UNTHA Recyclingtechnik GmbH; Wanner Technik GmbH; Wittmann Robot.

FIG. 6 shows a comminutor (1) in accordance with the invention with a material collection chamber (2) which can be filled with the material to be comminuted (3) by metering or in batches. A material batch chamber (4) may be placed on the material collection chamber (2) which is essentially covered and may be equipped with a feeder (5). A lateral rotationally mounted rotor (6) is mounted in the material collection chamber (2) which is installed in a housing (7) and in the material collection chamber (2), a feed pressure regulator (8) is disposed which can move towards the rotor to maintain pressure on the material (3) to be comminuted. The control device (9) for the feed pressure regulator (8) is embodied in a manner such that the feed pressure regulator can be pivoted about an axis (10) and thus the material to be comminuted can be conveyed to the rotor (6) in batches and can be pressed onto the rotor which is equipped with cutting elements (12).

Feeding and pressing the material (3) in this manner guarantees that controllable quantities of material can be loaded onto the rotor (6).

If the rotor (6) cannot handle the quantity of material (3) fed via the feed pressure regulator (8) and the feed pressure exerted thereby, insofar as the comminuted material (13) is not conveyed sufficiently quickly from the rotor housing (7) , the pressure of the feed pressure regulator (8) is reduced in a manner such that the rotor can run freely because of the reduced applied pressure (free comminution). If the rotor power drops off, the feed pressure regulator (8) is used in order to convey material (3) to the rotor (6).

The degree of comminution of the comminuted material (13) can be adjusted by means of a perforated sieve or perforated plate (14) located below the rotor (6). FIG. 9 shows that hole plates with square (b) or round (a) holes are used, wherein the diameter or the size (for square or other shaped holes: the centre of the smallest and largest dimension of the holes) is preferably selected to be between 3 and 50 mm, particularly preferably between 5 and 30 mm, in particular between 8 and 20 mm.

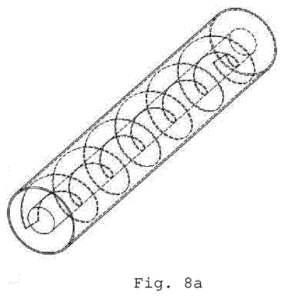

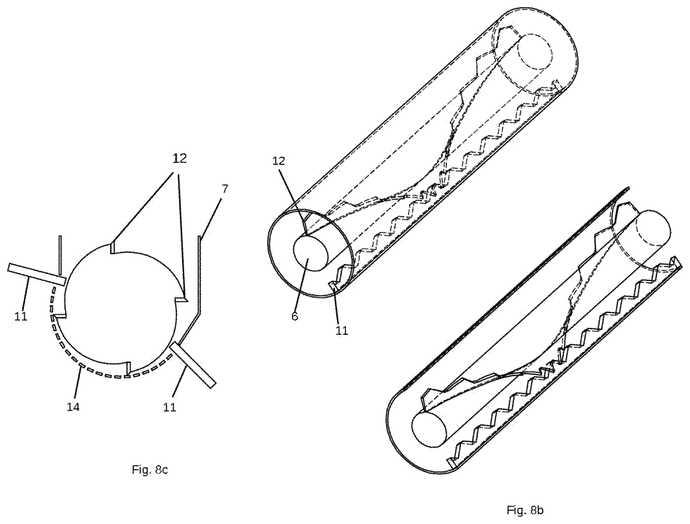

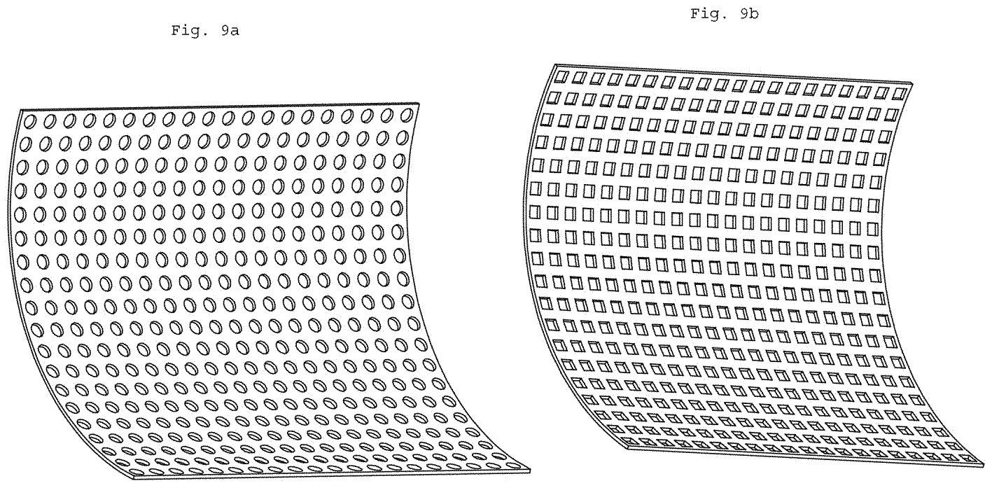

The rotor (6) may be equipped with cutting elements (12) such as hook-shaped shredders, blades or blade plates, or cutting edges over the entire periphery, running in a spiral (FIG. 8b) or wound sinusoidally, wherein the cutting elements are attached to the rotor blade holders by screws, or in fact could also be firmly welded. FIG. 7 shows a rotor with cutting elements of a comminutor which is constructed from individual offset elements. Preferably, the cutting edges and/or the counter-cutting edge is toothed. The cutting edge and the counter-cutting edge are substantially diametrically opposed with a maximum, narrow separation with respect to each other which is suitable for cutting or with substantially no separation, so that they can be moved past each other in order to cut. The toothed embodiment optimizes cutting and prevents the materials to be cut from sliding past. The tip of the tooth is preferably formed by edges at an angle of 160° to 30°.

Comminution of the material which is conveyed to it is carried out between the cutting elements (12) which are rotated with the rotor and stationary counter-cutting edges (11) which do not necessarily rotate, such as counter-cutting blades or stator chopping edges.

After comminution the waste, carried out between the rotating cutting elements (12) and the counter-cutting edges (11), the chopped material is immediately pressed through a hole plate (14) which determines the size of the cut material in accordance with the perforated sieve size and can be continuously discharged. By using a transport means (16) disposed below the rotor housing (7) and the discharge shaft (15), such as, for example, conveyor belts, conveyor augers, chain conveyors, or a vacuum unit, the comminuted product may optionally be conveyed further to a further comminution stage or to solvent leaching or washing.

The comminution in accordance with the invention and material preparation for further cut material treatment such as leaching, washing and solvent recovery may be carried out with a single shaft comminutor or multi-shaft comminutor in a horizontal and/or vertical configuration.

Similarly, the process in accordance with the invention may be used for coarse comminution as a pre-comminution stage with subsequent single or multiple stage fine comminution. The comminution size (coarse, fine) may be set by the size of the perforations.

The comminutor in accordance with the invention may be used for any cellulosic material and is not limited to the use of lyocell materials. Thus, the material from other shaped article production processes such as the viscose process or the cupro process may also be used. In these embodiments, the cellulosic material may be a derivatised cellulose, for example a cellulose xanthogenate or alkali cellulose. In the viscose process, wood pulp is transformed into alkali cellulose in several process stages by treatment with sodium hydroxide and by another subsequent reaction with carbon disulphide, it is derivatised into cellulose xanthogenate. After derivatisation, the final viscose spinning solution is produced by adding more sodium hydroxide and diluting water, which is pumped through spinnerets into an acid-containing spinning bath.

Here, coagulation of the viscose solution produces one viscose filament per spinneret hole. By means of drawing and further processing steps and combining the individual filaments, viscose filament strands are produced which are wound onto reels, or staple fibres are produced by additional cutting of the continuously spun viscose filaments. Downstream of the spinning process, desired and unwanted products are obtained which can be processed in accordance with the invention.

If the process in accordance with the invention is used in the viscose process, the main point is not the recovery of solvent, but the environmentally friendly discharge of the spinning and residual fibre waste, in particular with the auxiliary aid of comminution. Similar process steps are used in the derivatisation of cellulose using the cupro process. In the cupro process, wood pulp is dissolved in an ammoniacal solution of tetraamine copper(II) hydroxide. The solution is formed and the shaped articles obtained in the desired or unwanted form, as waste, are processed in accordance with the invention, in particular comminuted. Examples of shaped articles in each embodiment are filaments, staple fibres, films, membranes.

Naturally, the use in the lyocell process is preferred, because here there is a synergistic effect with solvent recovery. Even the addition of liquids during the comminution process is possible. By adding water, solvent or non-solvent or other precipitation agents, the waste material to be comminuted in the comminution stage can on the one hand be treated for further precipitation and extraction of the material, and/or be cooled at the same time on the other hand.

In this regard, the invention also concerns a comminutor with a rotor with protruding grating or cutting elements, as well as one or more counter-cutting edge (s), wherein the cutting elements slide past the counter-cutting edges, so that shaped articles or shaped article waste between the cutting elements and the counter-cutting edges are comminuted. These shaped articles or shaped article waste preferably contain cellulose, in particular after a shaping process in solution, such as the lyocell process, viscose process or the cupro process. The invention also concerns a process for comminuting these shaped articles or shaped article waste by means of the comminutor. Preferably, the comminutor has a feed pressure regulator which presses the shaped articles or shaped article waste to be comminuted against the rotor or the grating or cutting elements. Preferably, the comminutor has any one or more of the aforementioned features, or all of them. Preferably, the cutting edges and/or the counter-cutting edges are toothed. Preferably, a sieve is provided close to and/or below the rotor in order to control the size of the cut material.

(c) Extraction of Cellulose Solvent

The extraction of the cellulose solvent is the same for all of the solids processed in step (b) of the process. Typically, this is carried out at temperatures between 15° C. and 30° C. and for a grain size of less than 30 mm, requires a dwell time of 0.5 to 2 hours. In this regard, constant stirring and suspension of the solid is advantageous.

The following optional actions may be carried out in order to speed up extraction:
Increasing the mean extraction temperature from 40° C. to 70° C. increases the extraction rate of a material and reduces the required dwell time to approximately a quarter. When this temperature increase can be carried out by means of heat recovery from an otherwise unused waste heat flow, this is particularly preferable.
A reduction in the grain size reduces the required dwell time.
When the extraction is carried out in multiple stages following the counter current principle, this reduces the requirements for each individual extraction stage because the probability that parts of the waste product which are still loaded with solvent will immediately leave the extraction tank in the next step of the process falls.

The extraction is preferably carried out in an open or closed container, tank or basin. The solvent-solid mixture is set in motion, either by stirring or by causing a flow using a pump. Optionally, the temperature can be specifically raised to a value either by pre-heating the solvent feed, or in fact by adding steam directly to the process.

(d) Dewatering

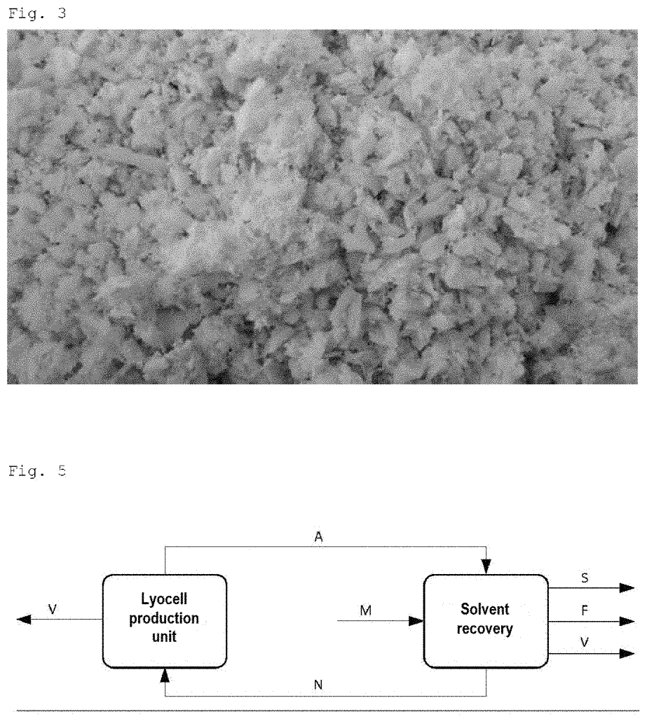

The solid extracted or partially extracted in step (c) of the process is separated from solvent-containing water during dewatering. The dry matter content obtained here is pivotal to the efficiency of the extraction step. The solid dewatered in this manner can now either be fed to a fresh extraction stage, or with sufficiently low solvent contents, can be flushed out of the process as a waste product. An example of a waste product of this type is shown in FIG. 3. The target concentration for the solvent in the waste solid should be less than 3% having regard to the recovery rate. A further reduction in the solvent concentration may be advantageous, depending on investment costs for the process protocol that would be required.

The solids separated in step (d) of the process may be fed to another type of process. Thus, for example, the separated cellulose components may be used as a compost material, as a construction supplement in road construction, for drainage filling or for embedding.

In the first dewatering step, the aim is to separate the solid from the solvent coarsely, Because both solid and filtrate will be sent to a further stage for processing, there is no particular requirement for fine separation. Thus, continuously running solid-liquid separators are particularly suitable, such as, for example:
PSS Separator from FAN Separatoren GmbH
PSS Separator from Erich Stallkamp ESTA GmbH
MDF Rotary Microfilter from ABZ Zierler GmbH
Belt Press from Flottweg SE

In the final dewateringstep, the aim is to free the solvent-free waste solid as far as possible from the liquid, and in this regard to reduce the solids content in the filtrate to a minimum. In this regard, in general, the aforementioned tools may be used, but preferred tools are, for example: the Chamber Filter Press from Welders Filtration Technology NV SA; or the Decanter Centrifuge from Flottweg SE.

Ultrafiltration units:

Aqua-System Technologie GmbH; Krones AG; OSMO Membrane Systems GmbH;

Microfiltration units:

Annen Verfahrenstechnik GmbH; Atec Automatisierungstechnik GmbH; ECOFLUID Handels GmbH; Hydro-Elektrik GmbH; Lanz-Anliker AG; Lenzing Technik GmbH; Tetra Pak Processing GmbH; WAG Wasseraufbereitung GmbH;

Reverse osmosis units:

AS Schmertmann GmbH; Decker Verfahrenstechnik GmbH; Enviro-FALK GmbH Prozesswasser-Technik; MembraPure Gesellschaft für Membrantechnik GmbH;

Ultrafiltration membrane manufacturers/Microfiltration membranes:

KOCH Membrane Systems GmbH/John Zink KEU GmbH; MICRODYN-NADIR GmbH; MTS & Apic Filter GmbH & Co. KG; SOMA GmbH & Co. KG; Reverse osmosis membranes:

CWG® Watertechnology GmbH; Kalle Wassertechnik; KOCH Membrane Systems GmbH/John Zink KEU GmbH; OSMO Membrane Systems GmbH; POREX Membrane.

(e) Collection and Cleaning of All Solvent-Containing Waste Water

The waste Rater produced in steps (a) to (d) of the process are preferably collected together with all of the solvent-containing waste water (6) produced in the lyocell unit.

Optionally, depending on the degree of contamination of the individual waste water flows, these can be freed separately, in one or more filters, from coarse sold contamination. The aim is for a maximum mean solid content of the solvent-containing collected waste water of 1000 mg/L or less, for example 20 to 1000 mg/L, preferably 200 mg/L or less and particularly preferably 50 mg/L or less.

The collected solvent-containing waste water is purified (preferably together) in one or more fine filtration stages. This filtration step can be carried out via one or more different filtration devices, wherein micro-sieve or multi-layered filters are particularly suitable. The aim of the filtration is to protect the subsequent process from fouling with solid particles. Depending on the selectivity, in this filtration stage, components that provide colour can be extracted; this is particularly preferred.

The waste water is generally collected in a liquid-tight and chemically resistant tank. The individual process waste water flows may be pre-filtered, as described. Examples of suitable equipment for this, depending on the degrees of contamination, are: edge gap filters, basket filters, or for coarser contamination, any of the solid-liquid separators mentioned in (d). The collected waste water is then fine filtered in order to protect the further downstream processes. Examples of generically used processes are: multi-layered filters, microfilter and membrane filter units.

(f) Deionization

In this step of the process, ionic impurities are removed with the aid of one or more anion and cation exchangers. The deionization normally takes place in a separate anion and cation exchanger, wherein a sequence of ion exchangers in the sequence configuration of anion exchanger followed by cation exchanger may be advantageous to the process.

The mean dwell time for the filtrate in the ion exchanger section provided in accordance with the process is between 2 and 20 minutes, particularly preferably between 8 and 12 minutes. The deionization acts to guarantee the reliability of the lyocell process, because harmful ions are removed.

(g) Concentration/Enrichment of the Solvent

In the next part of the process, the cellulose solvent is sent for concentration, for example to a multi-stage evaporation unit. In this regard, at least a concentration of the solvent should be obtained so that the solution is once again suitable for dissolving or suspending cellulose. The solution concentration does not have to be reached yet, because when transferring from the cellulose suspension to the solution, non-solvent is removed. Preferably, at least 50% (% by weight) of the solvent is obtained. Furthermore, higher concentrations may be obtained in order to handle smaller volumes (for later dilution with non-solvent). The preferably more than 70%, preferably 83% to 85% (percentage by weight) evaporated cellulose solvent is subsequently supplied as makeup solvent to the cellulose suspension production step of the process for further use.

The recycled aqueous solvent streams are used as makeup solvent in the continuously operated solution production. The process in accordance with the invention thus enables the organic residual or raw materials as well as waste water accruing in a cellulose fibre production process to be returned to its original useable state, and enables the solvent circuit to be closed.

Furthermore, the fact that the process is carried out with sustainable degradable raw or residual materials results in a balance which is well-balanced with respect to CO₂ emissions and which is environmentally neutral, because the separated solvent-free solid cellulose can unhesitatingly be sent for composting.

Further details, features and advantages of the invention will become apparent from the description below of an exemplary embodiment, made with the aid of the figures.

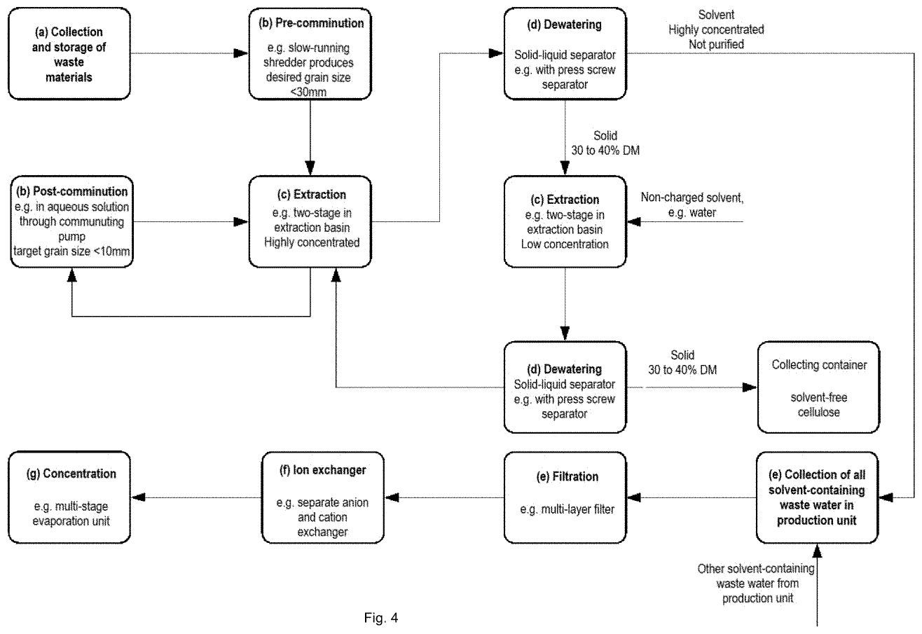

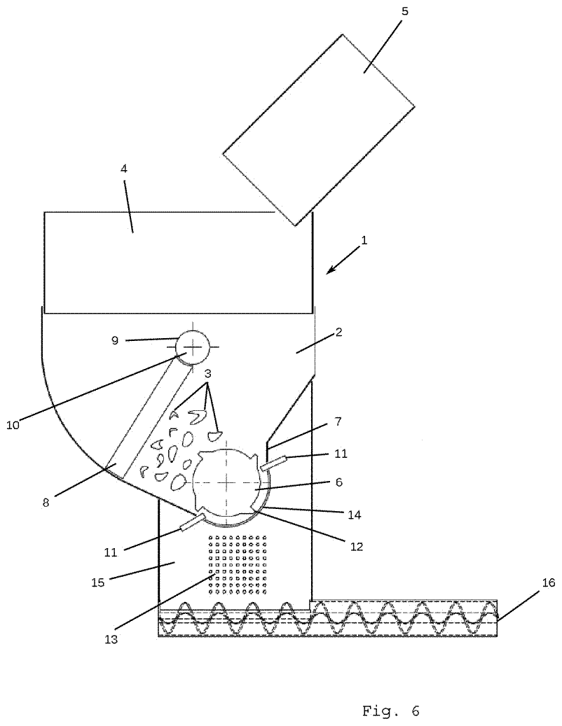

FIG. 4 diagrammatically shows a simplified block diagram, wherein this diagram shows both a process diagram in accordance with the invention and also the construction of a device in accordance with the invention suitable for carrying out a process in accordance with the invention. In addition to the basic components of the process in accordance with the invention or the device in accordance with the invention, FIG. 4 also shows further elements as components of preferred embodiments.

It lists examples of various types of apparatus that could be used. This is not an exhaustive list, and the individual apparatus could be replaced by other machines which achieved a similar effect in the process at any time.

In order to calculate the recovery rate for the solvent, in particular N-methyl morpholine N-oxide, in the lyocell production unit, a simple balance can be established by using this process.

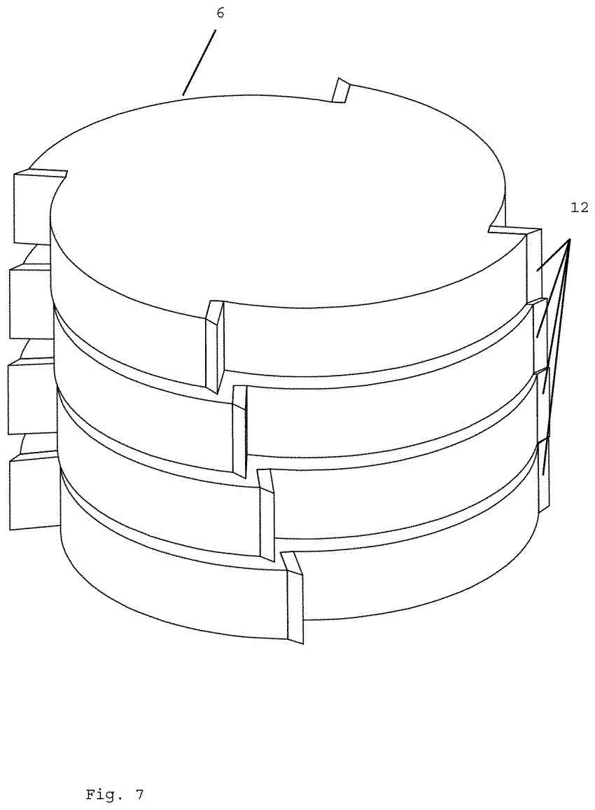

FIG. 5 shows the solvent circuit in the lyocell process:
Stream A contains all of the solvent-containing waste solids ((1) to (5)) as well as waste water ((6)).
Stream S represents the sum of the pressed waste solids occurring in step (e) of the process which leave the production and recovery unit.
Stream F represents the sum of the waste water flows which leave the production and recovery unit.
The two streams V represent other as yet undescribed solvent losses. This include, inter alia, thermal degradation losses and losses in the cellulose product produced. The further calculation is worked with the sum of all relevant losses as a single stream.
Stream M represents the makeup stream for the solvent which is necessary to compensate for the solvent losses.
Stream N represents the concentrated solvent stream which is recycled to the production process.

The following function for the recovery rate RGR is obtained from this balance:

RGR=1−F_{F}−F_{S}−F_{V}

wherein the loss factors F_{F}, F_{S} and F_{V} are defined as follows:

$${F}_{F} = \frac{{\dot{m}}_{FNMMO}}{{\dot{m}}_{ANMMO}} , {F}_{S} = \frac{{\dot{m}}_{SNMMO}}{{\dot{m}}_{ANMMO}} and {F}_{V} = \frac{{\dot{m}}_{VNMMO}}{{\dot{m}}_{ANMMO}}$$

wherein, for example, \dot{m}_{S,NMMO}, with the units kg/h, represents the mass flow of the solvent (for example N-methyl morpholine N-oxide), which on average is in stream F of FIG. 5. Thus, the factor F_{F} describes the ratio of the solvent stream which is lost in the waste water in the lyocell process, with respect to the entirety of the solvent employed, F_{S} describes the ratio of the solvent stream which is lost in the solid waste in the lyocell process with respect to the entirety of the solvent employed, and F_{V} describes the ratio of all solvent streams which are not contained in F_{F}, or F_{S} and which are lost in the lyocell process, with respect to the entirety of the solvent employed.

The solvent stream F in the context of this process is strongly dependent on the configuration of the ion exchange step (f) of the process. Empirical values for the resulting loss factor F_{F} are approximately 0.0033.

The undefined total loss stream V in the context of this process is dependent on the configuration of the concentration step (g).

The loss factor F_{S} is alone dependent on the solvent remaining in the solid waste of step (d) of the process, which is dependent on steps (a) to (d) of the process and the selected variations of the process and apparatus employed therein.

As an example of a good configuration for this process, the loss factor can be calculated as follows:

The estimates given in. Table 6 for the individual waste streams provide mean quantities for the daily solid waste of approximately 8% to 25% of a normal hourly production of dope in normal operation.

From this, in step (e) of the process, a washed, pressed solid waste is obtained which still has a residual solvent content.

This can be calculated using the following formula:

\dot{m}_{S,NMMO}=\dot{m}_{S}·w_{S,NMMO}

wherein \dot{m}_{S} is the total mean waste stream S in kg/h and w_{S,NMMO} is the mean solvent concentration as a percentage by weight in this waste stream S.

For the maximum estimated value for the mean solid waste collected in step (a) of the process under normal operation of 25% per day of normal hourly production of dope, this results in a loss factor F_{S} of less than 0.0001 for a residual solvent concentration w_{S,NMMO} of 3% in the waste product from step (d) of the process.

1. A process for regenerating a solvent for cellulose in a process for the production of shaped cellulose articles, comprising the steps of:
A) continuously or discontinuously producing solid shaped cellulose articles from a cellulose solution, comprising the steps of:
i) providing a cellulose solution of dissolved cellulose and a cellulose solvent and preferably a non-solvent, particularly preferably water;
ii) shaping the cellulose solution into a desired geometrical shape;
iii) consolidating the shaped cellulose solution into shaped cellulose articles in a coagulation liquid;
iv) releasing or extracting the solvent from the shaped cellulose articles using a non-solvent;
wherein, during the continuous or discontinuous process, shaped article waste from the cellulose solution accrues in an unwanted shape and optionally in the desired shape;
B) collecting the shaped article waste in the unwanted shape and optionally in the desired shape;
C) comminuting the optionally solvent-containing and/or non-solvent-containing shaped article waste from step B); and
D) extracting solvent from the comminuted shaped article waste.

2. The process as claimed in claim 1, characterized in that shaping of the cellulose solution in step ii) is spinning solution extrusion, or spinning into strands, filaments or films, wherein the shaped article waste in the unwanted form is in the form of clumps of the strands, filaments or films.

3. The process as claimed in claim 1, characterized in that desired or unwanted shaped article waste after shaping, either alone or with solid solvent-containing cellulose waste which accrues prior to shaping or after comminution, is mixed and comminuted together.

4. The process as claimed in claim 1, wherein the comminution in step C) is carried out by the action of mechanical force, preferably in a mill.

5. The process as claimed in claim 4, characterized in that for comminution, a comminutor with a rotor with one or more protruding cutting elements and one or more counter-cutting edge(s) is used, wherein the cutting elements slide past the counter-cutting edges so that shaped articles or shaped article waste between the cutting elements and the counter-cutting edges are comminuted and the shaped articles or shaped article waste are continuously or discontinuously conveyed to the cutting elements for comminution by means of a pressure maintaining device.

6. The process as claimed in claim 1, characterized in that the solvent for cellulose is N-methyl morpholine N-oxide or an ionic solvent, preferably with an ammonium, pyrimidium or imidazolium cation, particularly preferably 1,3-dialkyl imidazolium, particularly preferably butyl-3-methyl imidazolium or 1-ethyl-3-methyl imidazolium.

7. The process as claimed in claim 1, characterized in that the solvent or the aqueous solvent mixture of the solvent-containing washing and cutting liquids from step A) iv) and the solvent-containing aqueous extraction liquids from step D) are concentrated after dissolving or extraction; preferably in order to obtain a solution of cellulose solvent which is suitable for dissolving or suspending cellulose, or preferably in a concentration of at least 50% (% by weight) of solvent in the solution, in particular in the case of N-methyl morpholine N-oxide as the solvent.

8. The process as claimed in claim 7, wherein the concentration comprises evaporation of non-solvent, preferably water; or crystallization of the solvent, and/or a dynamic separation process.

9. The process as claimed in claim 1, characterized in that coagulation liquid from which shaped cellulose articles from step A) iii) are separated after transport from a container with coagulation liquid and is collected together with extracted solvent from step D).

10. The process as claimed claim 1, characterized in that the coagulation liquid is in a container and a collecting basin for collecting cellulose solvent draining out of the container because of the transport of shaped cellulose articles is associated with the container.

11. The process as claimed in claim 1, characterized in that the steps A) i) to iv) are carried out in one or more spinning unit(s), wherein solvent-containing aqueous coagulation liquid discharged from the spinning unit is collected via a channel or a channel system and mixed together with the solvent or aqueous solvent mixture from step iv) and fed for cleaning, concentration and recycling.

12. A device for regenerating a solvent for cellulose in a process for the production of shaped cellulose articles, comprising: a dope production unit; a dope filtration unit; a spinning unit with an extruder, extrusion pumps; heat exchangers; extrusion tools; spinnerets; a container for coagulation liquid which is disposed downstream of a gap below the extruder, preferably spinnerets, a withdrawal device; a cutting device; a solids collection container for consolidated shaped cellulose articles; a comminutor for consolidated shaped cellulose articles; a mechanical separation unit for separating solids contained in liquids; an ion exchange unit; and a unit for concentrating the aqueous cellulose solvent, or combinations thereof.

13. The device as claimed in claim 12, further comprising one or more collecting basins for collecting aqueous solvent during transport of desired shaped articles or shaped articles which are produced by shaping into geometrical shapes, or cellulose solution in an unwanted shaped cellulose article shape accrued from one or more coagulation liquid containers during the continuous process separating cellulose solvent or aqueous cellulose solvent; and/or with a channel at the bottom for systematic collection and conveying of solvent-containing liquid from the dope production unit, dope filtration unit, spinning unit, and from the evaporation unit, which is fed into a liquid collecting container.

14. The device as claimed in claim 12, with an evaporator for evaporating non-solvent from cellulose solvent-containing liquids.

15. The device as claimed in claim 12, characterized in that the comminution is in at least two stages, preferably comprising the steps of coarse comminution and fine comminution, the comminution is optionally carried out dry and/or wet, preferably with hammer mills, centrifugal mills with sieves with openings or cutting machines, tearing machines and/or grating machines, preferably with a rotor with protruding grating or cutting elements as well as with a sieve with openings, wherein the grating, tearing or cutting elements are guided over the sieve openings.

16. The process of claim 1, wherein said non-solvent is water or an aqueous medium.
